(19) United States
(12) Patent Application Publication
(10) Pub. No.: US 2008/0297515 A1
(43) Pub. Date: Dec. 4, 2008

(54) METHOD AND APPARATUS FOR DETERMINING THE APPEARANCE OF A CHARACTER DISPLAY BY AN ELECTRONIC DEVICE

(75) Inventor: Harry M. Bliss, Evanston, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/755,609

(22) Filed: May 30, 2007

(51) Int. Cl. G06T 5/00; G06T 15/70

(52) U.S. Cl. 345/473

(57) ABSTRACT

A method and an electronic device are for for selecting apparel for a character that is generated by an electronic device. The method and electronic device determine a changed context of the character, select an updated set of apparel for the character based on the changed context of the character, change the apparel of the character according to the updated set of new apparel; and present the character having the updated set of apparel on a display.

### RELATED APPLICATIONS

This application is related to a US application filed on even date hereof, having title “METHOD AND APPARATUS FOR DISPLAYING OPERATIONAL INFORMATION ABOUT AN ELECTRONIC DEVICE”, having attorney docket number CML02909EV, and assigned to the assignee hereof.

### FIELD OF THE INVENTION

The present invention relates generally to avatars and more specifically to apparel presented with a displayed character.

### BACKGROUND

Embodied Conversational Agents (ECA's) and avatars are known as user interface elements, for example, in games and on the internet, in chat rooms and internet shopping websites. Their use is attractive to certain market segments. Manual clothing customization for such animated avatars is already featured in avatar capable chat rooms and in virtual web based communities. In some existing applications, a user can manually select the clothing of the avatar in preparation for its appearance in a particular chat room or virtual community.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the present invention, and to explain various principles and advantages, in accordance with the embodiments.

FIG. 1 is an electronic block diagram of an electronic device, in accordance with some of the embodiments.

FIG. 2 is a flow chart that shows some steps of a method for determining the appearance of a character that is generated by the electronic device, in accordance with certain of the embodiments.

FIG. 3 is a functional block diagram of an electronic device, in accordance with some of the embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the embodiments, it should be observed that the embodiments reside primarily in combinations of method steps and apparatus components related to automatically changing the (virtual) apparel of an avatar in response to a context of the avatar. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

In this document, the term avatar is used to describe presentations of figures on a display of an electronic device that may be a wireless electronic communication device, such as a cellular telephone, or other electronic device that a person may use. Although the term avatar is used most often in this document to describe the figure, the figure may be one that could be referred to as an embodied conversational agent, as a character, or as a humanoid character. The avatar may be what is termed a 3D character, by which is meant (for technology commonly used today) that the character may be presented as a 2D figure with realistic shadowing that gives a 3D appearance. A use of characters in an electronic device can be desirable for at least some segments of the market for such devices and it is therefore useful to make the characters as interesting as possible, to enhance sales of the electronic devices.

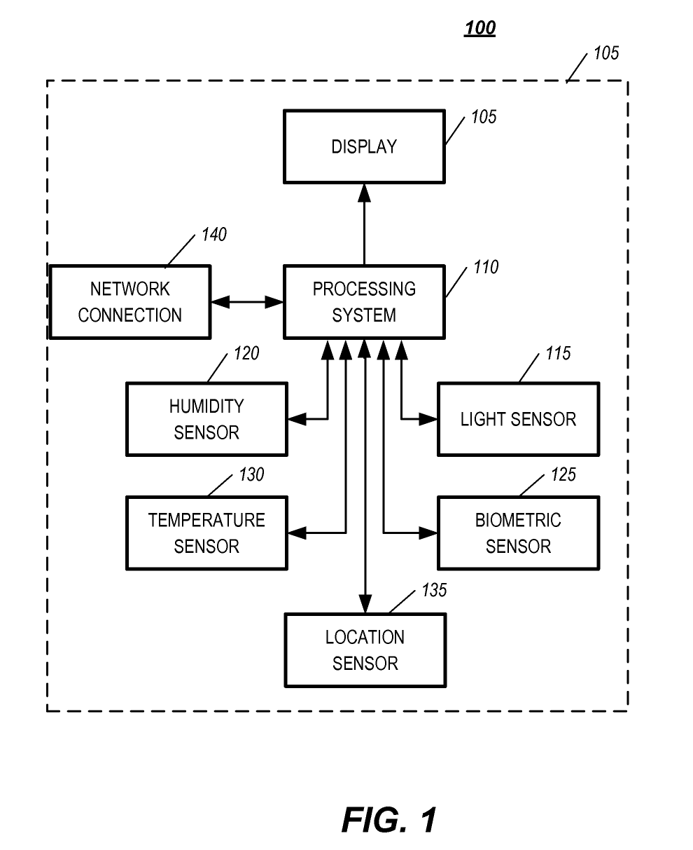

Referring to FIG. 1, an electronic block diagram of an electronic device 100 is shown, in accordance with some of the embodiments. The electronic device 100 comprises a display 105 that is driven by a processing system 110, and the processing system 110 may be coupled through a network connection 140 to a network, such as a local area network (which may of course be coupled to other networks). The processing system 110 may also be coupled to one or more of several environmental sensors, which are exemplified by a light sensor 115, a humidity sensor 120, a biometric sensor 125, a temperature sensor 130, and a location sensor 135. The processing system 110 may also be coupled to other environmental sensors, not shown in FIG. 1, such as an altitude sensor, an odor sensor, a gas sensor, a proximity sensor, an image sensor, and an accelerometer, and may include a time function. These environmental sensors each determine at least one aspect of the immediate environment of the electronic device 100. The electronic device 100 may be any device that can be carried by a person that includes a processing function, such as a cellular telephone, or a personal digital assistant, a handheld computer, an electronic game, or an electronic device that is a combination of one or more of these or other devices. The display is typically an integral part of the electronic device 100. The processing system 110, the display 105, the light sensor 115, the humidity sensor 120, the biometric sensor 125, the temperature sensor 130, and the location sensor 135 may be conventional electronic components or subsystems, or later developed electronic components or subsystems that can provide functions described herein, except that the processing system includes some uniquely organized program instructions not found in conventional processing systems that perform the unique functions described herein.

Among the functions performed by the electronic processing system is the formation of a context of the character. The context may be based on the sensor inputs and other information generated by applications or services that are run on the electronic device that is relevant to a choice of (virtual) apparel for the character, and is herein termed the context of the character. An example of such information generated by applications run on the electronic device is an appointment from an appointment application or a weather report from a network weather service. Thus, the context of the character may comprise one or a combination of ambient temperature, ambient humidity, ambient lighting, current location, and a detected emotion of the user (based, for example on a biometrics sensor, such as a pulse rate detector). It will be appreciated that the context of the character is one that may also closely represent a context of the user of the electronic device.

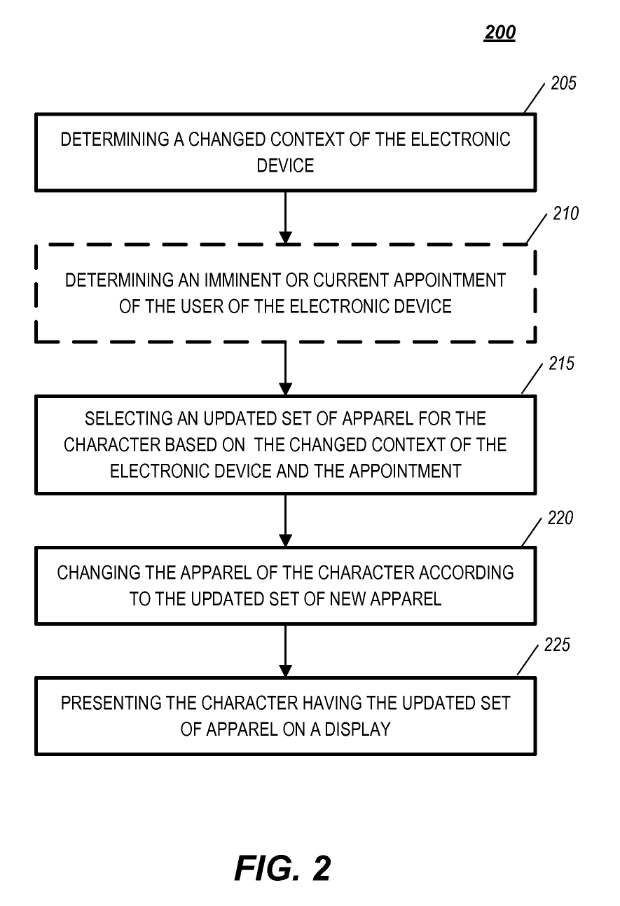

Referring now to FIG. 2, a flow chart shows some steps of a method for determining the appearance of a character that is generated by an electronic device, such as electronic device 100, in accordance with certain of the embodiments. In some embodiments, the method is automatic—which means that the described steps are executed by a processing system of the electronic device (that runs under control of software instructions stored within the electronic device), without human input being required during the execution of the steps of the method. At step 205, a change in the context of the character may be automatically determined by the processing system from a change in one of the sensor inputs or from information determined from an application or service that is relevant to a choice of the character's apparel, such as a determination of an imminent appointment. At step 210, an imminent appointment of the user of the electronic device is optionally determined. In some embodiments, an imminent appointment may be determined at a time that precedes the appointment by a set amount, such as 15 minutes. In some embodiments, the imminent time may be determined by simply determining that the time on a clock that is maintained by the processor is equal to a time of the appointment (i.e., the time that precedes the appointment may be set to zero). In some embodiments, a distance to a location of an appointment may be stored in the electronic device or may be determinable by the processing system, and the distance may by used to determine a time before the appointment at which the appointment is imminent. At step 215 an updated set of apparel for the character is selected that best corresponds to the changed context of the character and the imminent or current appointment. In some embodiments, the selection of the updated set of apparel may be aided by the processing system making a presentation of alternative choices of an apparel item, which may include preferences derived from the context determined by the (processing system of the) electronic device. The user may then make the selection of one or more items of apparel. This approach, which is termed a semi-automatic method, may be applicable only when the change of context is based on an input from a calendar or appointment book. The (virtual) apparel of the character is then changed at step 220 according to the updated set of new apparel. At step 225 the character having the updated set of apparel is presented on a display. In some embodiments, the character is an avatar (i.e., the avatar is humanoid).

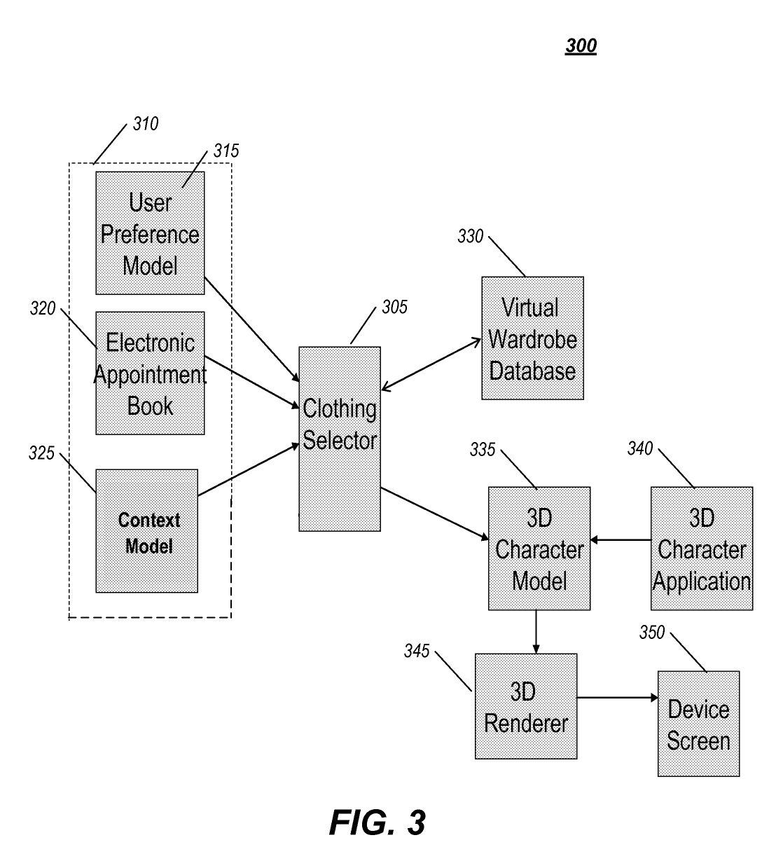

Referring to FIG. 3, a functional block diagram of an electronic device 300 is shown, in accordance with some of the embodiments. The electronic device 300 may be the same as the electronic device 100. The electronic device 300 has a processing system (not shown in FIG. 3) that includes a clothing selector function 305. The clothing selector function 305 may receive input from other functions 310, including ones that may maintain a user preference model 315, an electronic appointment book 320, and a context model 325. The context model 325 is a function that maintains substantial information about the context of the character, such as an ambient temperature of the electronic device 100 as determined by the temperature sensor 130, an emotion of a user of the electronic device 100 as determined from data provided by the biometric sensor 125, a location of the electronic device as determined by a GPS input 135, a local weather for the location as determined from a network input 140, etc. The context model 325 maintains current values for these items and determines when a change occurs that is significant, in which case the event is communicated to the processing system 110 as a change, including a new value or values of such items. The collection of values maintained by the context model 325 are used to determine at least a portion of a context of the character, and may also be interpreted as at least a portion of a most likely context of a user of the electronic device 100. That is, the user of the electronic device 100 may think of the character as a representation of himself and may react to the character's choice of apparel since it is chosen from inputs that tend to emulate the user's world. The electronic appointment book 320 is an application of the type mentioned above that generates information relevant to a choice of apparel for the character. The electronic appointment book 320 maintains appointments for the user of the electronic device 100 and determines imminent or current appointments. Such imminent appointments are communicated to the processing system 110, along with particulars about the appointment, and may constitute at least one part of a context of the character, and may also be interpreted as at least one part of a most likely context of a user of the electronic device 100. The electronic appointment book 320 may include in certain embodiments locations of some appointments, a type of appointment (e.g., a formal dinner, a sports event, a doctor's appointment) and/or a set preparation time, either of which may be used by the electronic appointment book 320 to determine an imminent appointment, as described herein with reference to FIG. 2, which may be interpreted as a change of context of the character. The user preference model 315 stores a set of user preferences that may include, for example, preferences of the user of the electronic device for clothing color combinations, for types of apparel to be worn at various temperatures and for various types of appointments.

As an alternative to the context model 325, and optionally also as an alternative to one or both of the electronic appointment book 320 and the user preference model 315, information that would otherwise be provided by these functions could be provided through the network connection 140 from a virtual world model, such as one available at http://secondlife.com, or from a virtual world that is maintained within the electronic device in a separate application, such as a game application. In yet other embodiments, some but not all portions of information that would otherwise be provided by one or more of the context model 325, the electronic appointment book 320, and the user preference model 315 would be provided by a virtual world model.

A virtual wardrobe function 330 maybe coupled to the clothing selector function 305. The virtual wardrobe function 330 includes digital definition for each of a plurality of items of apparel that may be used by the electronic device to dress or equip the character with a set of items of the apparel. This may include a database that defines for each apparel item such things as sleeve lengths, the existence of a collar on a shirt, a pattern, colors of the pattern, and direction of the pattern for a shirt, blouse, dress, pants, or tie, etc., the locations of buttons, the color and shape of a belt and belt buckle, the shape, color, and pattern of hats, scarves, shoes, and socks. Thus, the items of apparel may include one or more items of headwear, neckwear, eyewear, jewelry, upper body clothing, lower body clothing, gloves, and footwear.

In certain embodiments, the items of apparel may include certain accessories such as handkerchiefs, umbrellas, purses, and briefcases. The virtual wardrobe function includes metadata about each apparel item that is used for selection of the items of apparel, such as color information, weather appropriateness (i.e., warmth or temperature appropriateness), and usage appropriateness (i.e., a correspondence to an appointment type).

The clothing selector function 305 uses the report of changes in context of the character generated by the context model 325 and the electronic appointment book 320, as well as information from the context model 325 and the electronic appointment book 320 concerning the new context (i.e., current values reported by the sensors, inputs, and present appointments), as well as the user preferences stored by the user preference model 315 to determine a best correspondence of the apparel of the character to the changed context of the character by optimizing a metric determined by the metadata of each of the set of items of apparel in the virtual wardrobe database 330. Examples of how the clothing selector would make clothing determination could be a rule based system, a logical reasoning system, statistical processing system, a neural networks system, or other reasoning engines known to the art. It will be appreciated that the clothing database could be extended to one or more databases external to the electronic device 100 by use of the network interface 140. When a best correspondence has been determined, the digital definition of the apparel of the character is coupled to a character model 335, along with a set of digital data that defines the character, obtained from a 3D character application 340 that is also coupled to the 3D character model 335. The 3D character model 335 combines the digital data appropriately and couples the result to a 3D renderer 345, that provides image data for display on a device screen 350.

It will be appreciated by now that method and apparatus for automatically selecting apparel for a character that is generated by an electronic device has been described. The method and apparatus automatically selects the apparel in response to changes in a context of the character that are determined by the electronic device. The context of the character may be very close to a context of the user of the device. As a result, certain users of electronic devices may be attracted by this enhanced feature to pay more for electronic devices that can perform this function.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, sensors, and user input devices. As such, these functions may be interpreted as steps of a method to perform {replace with a technical description of the invention in a few words}.

Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein.

In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method performed within an electronic device for selecting apparel for a character that is generated by an electronic device, comprising:
determining a changed context of the character;
selecting an updated set of apparel for the character based on the changed context of the character;
changing the apparel of the character according to the updated set of new apparel; and
presenting the character having the updated set of apparel on a display.

2. The method according to claim 1, wherein the context of the character is at least partially based on a physical environment sensed by the electronic device.

3. The method according to claim 1, wherein the context of the character is representative of a likely context of the user of the device.

4. The method according to claim 1, wherein the context comprises at least one of sensed ambient temperature, sensed ambient humidity, sensed ambient lighting, sensed present location, reported weather, and an emotion of the user determined from a sensed input.

5. The method according to claim 1, further comprising determining a current or imminent appointment of the user of the electronic device, wherein selecting an updated set of apparel for the character is further based on the imminent appointment of the user of the electronic device.

6. The method according to claim 1, further comprising:
determining the best correspondence of the set of apparel of the character to the changed context of the character using a function that optimizes a metric determined by metadata of each of a plurality of items of apparel and the context of the device and user preferences of the user of the device.

7. The method according to claim 1, wherein the character is a humanoid character.

8. The method according to claim 1, wherein the items of apparel include one or more of headwear, neckwear, eyewear, jewelry, upper body clothing, lower body clothing, gloves, and footwear.

9. The method according to claim 1, wherein the electronic device is a handheld electronic device.

10. An electronic device that stores a character, comprising:
a processing system that includes
a context function for determining a changed context of the character;
a clothing selection function for selecting an updated set of apparel from a clothing database for the character based on the changed context of the character;
a character model function for maintaining and changing the apparel of the character according to the updated set of new apparel; and
a display for presenting the character having the updated set of apparel.

11. The electronic device according to claim 10, further comprising at least one environmental sensor, wherein the context of the character is at least partially based on an aspect of the immediate physical environment of the electronic device sensed by the environmental sensor.

12. The electronic device according to claim 10, wherein the context of the character is representative of a likely context of the user of the device.

13. The electronic device according to claim 10, wherein the at least one environmental sensor is at least one of an ambient temperature sensor, an ambient humidity sensor, an ambient lighting sensor, a biometric sensor, and a location sensor,

14. The electronic device according to claim 10, wherein the processing function further comprises an electronic appointment function that determines a current or imminent appointment of the user of the electronic device, and wherein the selecting of an updated set of apparel for the character is further based on the imminent appointment of the user of the electronic device.

15. The electronic device according to claim 10, wherein the processing system further comprises a clothing selector function that determines the best correspondence of the set of apparel of the character to the changed context of the character using a function that optimizes a metric determined by metadata of each of a plurality of items of apparel and the context of the device and user preferences of the user of the device.

16. The method according to claim 10, wherein the character is a humanoid character.

17. The method according to claim 10, wherein the items of apparel include one or more of headwear, neckwear, eyewear, jewelry, upper body clothing, lower body clothing, gloves, and footwear.
